(19) United States
(12) Patent Application Publication
(10) Pub. No.: US 2024/0201208 A1
(43) Pub. Date: Jun. 20, 2024

(54) Determining physical parameters of a liquid with simulation

(71) Applicant: Tecan Trading AG, Maennedorf (CH)

(72) Inventors: Michael Keller, Bauma (CH); Thomas Geiges, Maennedorf (CH); Volfgang Vilaj, Uetikon am See (CH)

(21) Appl. No.: 18/527,954

(22) Filed: Dec. 4, 2023

(30) Foreign Application Priority Data
Dec. 14, 2022 (EP) 22213600.4

(51) Int. Cl. G01N 35/00; G01N 35/04

(52) U.S. Cl. CPC G01N 35/00584; G01N 35/04; G01N 2035/0434

(57) ABSTRACT

A method for determining physical parameters of an unknown liquid to be aspirated and/or dispensed by a laboratory automation device comprises: determining physical parameters of a pipette, the physical parameters including geometric parameters of the pipette, which at least include a tip radius of an orifice of the pipette; aspirating and/or dispensing the unknown liquid with a pipette of the laboratory automation device and measuring a measured pressure curve in the pipette during aspirating and/or dispensing; determining the physical parameters of the unknown liquid by minimizing an objective function depending on a difference between a simulated pressure curve and the measured pressure curve, wherein the simulated pressure curve simulates a pressure in the pipette during aspirating and/or dispensing and is calculated based on a physical model of the laboratory automation device including the physical parameters of the pipette.

### RELATED APPLICATIONS

The present application claims priority to EP Patent Application No. 22213600.4, filed Dec. 14, 2022, the contents of which are hereby incorporated by reference in their entirety.

### BACKGROUND INFORMATION

Laboratory automation devices are used for automating tasks of a laboratory assistant, which, for example, tests a patient for specific diseases. Usually, a sample of the patient's blood, urine, stool, etc. is taken and analyzed by means of a bio-chemical procedure. Such a procedure consists in various operations like adding substances, incubating, separating, etc. and a measurement process which quantitatively or qualitatively measures the amount or presence of a substance indicating the specific disease.

Sometimes laboratory automation devices need to deal with unknown liquids or with liquids such as blood, which have varying physical properties such as density and viscosity. In these cases, it may be that the user of the laboratory automation device wants to know the properties of the liquid. It also may be that the physical properties have to be determined to calculate and set the liquid class parameters. A liquid class for a specific liquid is used for controlling the laboratory automation device, when the laboratory automation device processes this liquid.

U.S. Pat. No. 7,964,160 B1 describes a method for accepting and rejecting pipetted liquid samples. A liquid is aspirated and dispensed with the pipette of a laboratory automation device and a pressure cure is measured. A simulated curve, which is simulated based on physical properties of the laboratory automation device and the liquid, is fitted to the measured curve. During the fitting, parameters of the simulated curve are adjusted by comparing the measured curve and the simulated curve.

EP 1 745 851 A1 describes a method for selecting pipetting parameters of a laboratory automation device. An unknown liquid is set into oscillations in the pipette of the laboratory automation device and a pressure curve is measured. The pressure curve is compared with typical pressure curves of known liquids. When a typical pressure curve is identified, the pipetting parameters of the respective liquid are selected for the unknown liquid.

### BRIEF DESCRIPTION OF THE DRAWINGS

Below, embodiments are described in more detail with reference to the attached drawings.

FIG. 1 schematically shows a laboratory automation device according to an embodiment.

FIG. 2 shows a flow diagram illustrating a method according to an embodiment.

FIGS. 3 and 4 show diagrams with pressure curves produced by the method of FIG. 2.

FIG. 5 shows a diagram for describing an objective function used in the method of FIG. 2.

FIG. 6 shows a diagram with values of the objective function generated in the method of FIG. 2.

The reference symbols used in the drawings, and their meanings, are listed in summary form in the list of reference symbols. In principle, identical parts are provided with the same reference symbols in the figures.

### DETAILED DESCRIPTION

Described herein are a method, a computer program, a computer-readable medium and a control device for determining physical parameters of a liquid. Furthermore, the method relates to a laboratory automation device.

It is a feature described herein to automate and simplify the determination of physical parameters of liquids used in the context of laboratory automation.

A first aspect relates to a method for determining physical parameters of an unknown liquid to be aspirated and/or dispensed by a laboratory automation device. The method may be performed automatically by the laboratory automation device and in particular a control device of the laboratory automation device. A control device of a laboratory automation device, which control device is adapted for performing the method, also is a further aspect.

The method comprises: determining physical parameters of the pipette, the physical parameters including geometric parameters of the pipette, which at least include a tip radius of an orifice of the pipette. The geometric parameters define a geometric shape of the pipette, in particular from the tip section of the pipette. Small deviations of the geometric shape of the pipette section may substantially influence the pressure curve, from which the physical parameters of an unknown liquid are determined as described below.

The tip radius may be the smallest radius of the orifice of the pipette.

According to an embodiment, the geometric parameters of the pipette comprise additionally at least one of: a geometric model of at least one conical section modelling an interior surface the pipette; an opening angle of a conical section ending in the orifice; a second radius at another end of the conical section; a distance of the other end to the orifice; an opening angle and/or radii and/or distances of ends of further conical sections.

The physical parameters of the pipette may be determined by receiving corresponding measurements values, which for example may be encoded in a computer readable code on the pipette and/or its container. The computer-readable code may contain the physical parameters or the computer-readable code may guide to a database and/or server, which stores the physical parameters. As a further option, the physical parameter of the pipette may be determined by aspirating and/or dispensing a known liquid with known physical liquid parameters and evaluating a corresponding pressure curve.

According to an embodiment, the method further comprises: aspirating and/or dispensing a known liquid with a pipette and measuring a first measured pressure curve in the pipette during aspirating and/or dispensing, wherein the physical parameters of the pipette are determined by minimizing an objective function depending on a difference between a simulated pressure curve and the first measured pressure curve, wherein the simulated pressure curve simulates a pressure in the pipette during aspirating and/or dispensing and is calculated based on a physical model of the laboratory automation device including the physical parameters of the pipette and the known physical parameters of the known liquid, wherein the physical parameters of the pipette are varied to minimize the objective function.

The method further comprises: aspirating and/or dispensing the unknown liquid with the pipette or an equal pipette and measuring a measured pressure curve during aspirating and/or dispensing. In the case, when a first pressure curve is measured for the known liquid, the pressure curve measured during aspirating and/or dispensing the unknown liquid is a second pressure curve.

The two aspirating and/or dispensing steps may be performed in arbitrary order. The known liquid is a liquid, for which the physical properties, such as density, viscosity, surface tension and/or wetting angle, etc., are known. For example, the known liquid may be water, for which the physical parameters are known very well. The unknown liquid is a liquid, for which the physical properties are not known.

In the second step, instead of the pipette, an equal pipette, which may be an equally shaped and/or equally manufactured pipette, may be used. In such a way, in the second step, also an unused pipette, which has not yet been wetted, can be used. In the following, when the pipette is mentioned, also the equal pipette is considered and meant.

In both method steps, the pipette may be picked up with the laboratory automation device. For example, a pipetting arm may take the pipette. The pipette may be disposable. A disposable pipette may be called “pipette tip”, however, in the following, the end of the pipette with the orifices will be called pipette tip.

Both liquids may be provided in sample containers. The pipette may be lowered into the respective sample container with the laboratory automation device, the respective sample container containing the known liquid or the unknown liquid.

The first and second measured pressure curves may be measured with a pressure sensor of the laboratory automation device, which pressure sensor may be connected to the interior of the pipette. For example, the pressure sensor may be a part of the pipetting arm or the pump generating the pressure in the pipette.

In the one or more simulation steps, the relevant parts of the laboratory automation device, such as the interior of the pipette and the cavities, which interior is connected to the pipette, together with the known liquid and the unknown liquid, respectively, are simulated. This may be done by a controller of the laboratory automation device or any other computing device in data communication with the laboratory automation device. In a simulation step, which is performed, when the first pressure curve has been measured, the physical parameters of the pipette are determined with the simulation by adjusting the simulated curve to the first measured pressure curve. The known physical parameters of the known liquid are used as fixed parameters during this first step of the simulation and optimization. The adjustment of the simulated and measured curve may be achieved by an iterative optimization process. The unknown physical parameters of the pipette are varied, for example with a Monte Carlo method, a genetic algorithm, a steepest descent method. In every iteration step, the unknown physical parameters of the pipette are varied, such that the objective function is minimized.

The method further comprises: determining the physical parameters of the liquid by minimizing an or the objective function depending on a difference between a simulated pressure curve and the (second) measured pressure curve, wherein the simulated pressure curve simulates a pressure in the pipette during aspirating and/or dispensing the unknown liquid and is calculated based on a or the physical model of the laboratory automation device including the physical parameters of the pipette, wherein the physical parameters of the unknown liquid are varied to minimize the objective function.

In this simulation step, physical parameters of the unknown liquid are determined with the simulation by adjusting the simulated curve to the (second) measured pressure curve. The now known physical parameters of the pipette are used as fixed parameters during this simulation step of the simulation and optimization. The adjustment of the simulated and measured curve may be achieved by an iterative optimization process, which may be the same as in the first simulation step. The unknown physical parameters of the liquid are varied, for example with a Monte Carlo method, a genetic algorithm, a steepest descent method. In every iteration step, the unknown physical parameters of the liquid are varied, such that the objective function is minimized.

In both simulation steps, the relevant parts of the laboratory automation device are simulated during aspiration and optionally dispensing (see below). The relevant parts of the laboratory automation device and/or the model of the laboratory automation device used in the simulation may be the pipette, together with its orifice and/or the connected pressure system, such as hoses and pipes and the pump. Also, the liquid and the gas (usually air) inside these components are simulated:

The physical model used in the simulation may comprise differential equations, which are solved during the simulation. The differentiable equation may model the properties of components over time. For example, the volume of the liquid and of the gas inside the components may be modelled as linear interconnected, oscillating masses.

The physical parameters of the pipette and of the liquid are parameters of the differential equations, which are kept fixed during one iteration step. The respective physical parameters are varied as described above between two iterations steps and a new simulation is performed.

According to an embodiment, the physical parameters of the pipette additionally comprise a filter resistance. The filter resistance may be a flow resistance of one or more filters inside the pipette and/or in a tip adapter, which may belong to laboratory automation device.

As already mentioned, further physical parameters may be considered, such as a shape of a conical and/or cylindrical part of the pipette, the diameter and/or radius of the cylindrical part, of the pipette tip, a tip opening angle of the pipette tip and/or its orifice, etc. The physical parameters, however, may be kept fixed and need not be optimized during the first simulation step. The same applies to physical parameters of further parts of the laboratory automation device. All these physical parameters may be provided as fixed values.

According to an embodiment, the physical parameters of the liquid comprise at least one of a density, a viscosity, a surface tension and a wetting angle. It may be that one or some of these parameters are provided as fixed values and are not varied during the simulation. For example, solely the density and viscosity may be determined. However, it also may be that all of these physical parameters are determined in the second simulation step.

According to an embodiment, the method further comprises: aspirating and dispensing the known liquid and the unknown liquid with the laboratory automation device and measuring the first pressure curve and the second pressure curve during aspirating and dispensing. In this case, the simulated pressure curve simulates a pressure in the pipette during aspirating and dispensing and the objective function depends on the difference between the simulated pressure curve and the measured pressure curve during aspirating and dispensing.

For increasing the accuracy, both the aspirating and the dispensing of the respective liquid is simulated. The physical parameters are optimized with respect to aspiration and dispensing. In this case, also a receding wetting angle may be determined.

According to an embodiment, the objective function depends on pressure differences of the measured pressure curve and the simulated pressure curve at equal time points. At selected time points of the two curves, the pressure difference is calculated. The objective function is then calculated from these differences. For example, the objective function may be the root mean square of these differences and/or the sum of these differences. In the latter case, the objective function may be the integral over the difference between the simulated and measured pressure curve.

The time points may be selected to be within specific intervals of the curves. For example, an interval may be determined to start at the beginning of aspiration and to end, when the pressure curve has settled, i.e. stays on a constant value. A further interval may be determined to start at the beginning of dispensing and to end, when the pressure curve has settled.

According to an embodiment, the physical properties of the pipette are determined in one multidimensional optimization, in which the physical properties of the pipette are varied simultaneously. In every iteration step, all physical parameters of the pipette, which should be determined, are varied.

According to an embodiment, the physical properties of the unknown liquid are determined in one multidimensional optimization, in which the physical properties of the pipette are varied simultaneously. In every iteration step, all physical parameters of the unknown liquid, which should be determined, are varied.

According to an embodiment, the physical properties of the unknown liquid are determined in a multistep optimization, in which the physical properties of the pipette are varied in separate groups. Each group may be composed of one or more parameters, each parameter being or associated with a physical property. One group may be density and viscosity. Then the groups are optimized one after the other. This may decrease the computational demand of the simulations. According to an embodiment, the known liquid is aspirated with a first pipette and the unknown liquid is aspirated with a second, equal pipette. The equal pipette may be a pipette equally shaped as the (first) pipette. As already mentioned, the pressure curves may be measured for different pipettes, which, however, in a sense are equal. Equal may mean that the pipette and the equal pipette are picked from the same pipette container. Equal also may mean that the pipette and the equal pipette are manufactured with the same mold and in particular the same cavity of the mold. Usually, pipettes made with the same mold, for example an injection mold, are sorted into the same pipette containers. This may ensure that the pipettes have nearly the same shapes and in particular nearly the same physical parameters.

According to an embodiment, at least one initial value for the physical parameters of the unknown liquid are determined from at least one characteristic feature of the (second) measured pressure curve. The initial values for the physical parameter, which are used for starting the optimization, may be determined from characteristic features of the (second) measured pressure curve. In general, a characteristic feature may be a peak, the height and/or width of a peak, an inclination of a substantially straight curve piece, a pressure difference between two substantially straight curve pieces, etc.

In particular, a characteristic feature may be a height and/or direction of a peak at a beginning of the aspiration. This is indicative of a surface tension and wetting angle of the liquid.

A characteristic feature also may be a height and/or duration of a pressure change at an end of the aspiration. This is indicative of a viscosity of the liquid.

According to an embodiment, the pipette and/or the equal pipette is unused and has not been wetted with a liquid before. A wetting of the interior surface of a pipette before the aspiration may influence the determination of physical parameters, such as the surface tension, volatility, wetting angle and viscosity. Starting with an unused pipette will increase the accuracy of these parameters.

The determined physical parameters of the liquid may be output to a user of the laboratory automation device, for example for planning an assay procedure with the liquid.

According to an embodiment, the method further comprises: storing the physical parameters in a liquid class for the liquid; and optionally performing an assay procedure with the liquid using the liquid class. A predefined liquid class may be selected and the physical parameters there may be adjusted to the determined values. Also a new liquid class may be defined with the determined values.

It also may be that a liquid class for the liquid is stored in the control device. A liquid class is a data structure used by the control device and/or the laboratory automation device for handling the liquid. For example, the liquid class sets, how fast the liquid is aspirated and dispensed during specific steps of an assay procedure. Another example for a parameter in the liquid class is an accuracy correction or the a wait time after aspiration. An assay procedure may be a predefined set of operations that are automatically performed by the laboratory automation device for processing the liquid.

A further aspect relates to a computer program for determining physical parameters of a liquid, which computer program, when being executed by a processor, is adapted to carry out the steps of the method as described above and below. The computer program may be executed in a computing device, such as a control device of the laboratory automation device and/or a PC, which may be communicatively interconnected with the laboratory automation device. It also is possible that the method is performed by an embedded microcontroller of the laboratory automation device.

A further aspect relates to a computer-readable medium, in which such a computer program is stored. A computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. A computer-readable medium may also be a data communication network, e.g. the Internet and/or a cloud storage, which allows downloading a program code. In general, the computer-readable medium may be a non-transitory or transitory medium.

A further aspect relates to a laboratory automation device.

According to an embodiment, the laboratory automation device comprises a pipetting arm for carrying a pipette; a pump for changing a pressure in a volume connected to the pipette for aspirating and dispensing a liquid medium in the pipette; a pressure sensor for pressure measurements in the volume connected to the pipette and a control device for controlling the pump and the pipetting arm and for receiving a pressure signal from the pressure sensor, wherein the control device is adapted for performing the method as described above and below.

It has to be understood that features of the method as described in the above and in the following may be features of the control device, the computer program and the computer-readable medium as described in the above and in the following and vice versa.

These and other aspects will be apparent from and elucidated with reference to the embodiments described hereinafter.

FIG. 1 schematically shows a laboratory automation device 10, which comprises an automatically movable pipetting arm 12 to which a pipette 14 is attached. As shown in FIG. 1, the pipette tip 16 of the pipette 14 may be lowered into a sample container 18 via the movable pipetting arm 12.

The pipetting arm 12 may move the pipette 14 and the pipette tip 16 in three dimensions, may lower the pipette tip 16 into the sample container 18 and may retract the pipette tip 16 therefrom. The pipette 14 is a disposable pipette and the pipetting arm 12 is adapted for picking up the pipette 14 and discarding the pipette 14.

The pipette 14 contains a filter 20, which prevents entering substances from the pipette 14 into the remaining parts of the laboratory automation device 10.

In the sample container 18, a liquid 22 is contained. When the pipette tip 16 is immersed in the liquid in the sample container 18, the liquid can be aspirated into the pipette 14.

FIG. 1 also shows a further sample container 24 containing a further liquid 25. The liquid 25 is a known liquid with known physical parameters. The liquid 22 is an unknown liquid for which the physical parameters are determined with the method described herein.

The laboratory automation device 10 comprises a pump 26, which is connected via a hose 30 with the pipette 14. With the pump 26, a pressure may be applied to the hose 30 and to the pipette 14, or more general to a volume 30 connected with the pipette 14, which causes the pipette 14 to aspirate or dispense the liquid 22 or air. For example, the pump 26 comprises a plunger 28, which is moved for generating underpressure and overpressure in the hose 30 and the pipette 14. Any other kind of pumps, e.g. peristaltic pumps, or in general any source of vacuum and pressure may be used. The source of vacuum and pressure may be controlled via valves.

A pressure sensor 32, which may be attached to the hose 30 and/or the pipette 14, is adapted for measuring a pressure in the hose 30 and/or the pipette 14.

A control device 34 of the laboratory automation device 10, which may be a part of the laboratory automation device 10 or connected thereto, may control the pipetting arm 12, the pump 26 and may receive a pressure signal from the pressure sensor 32.

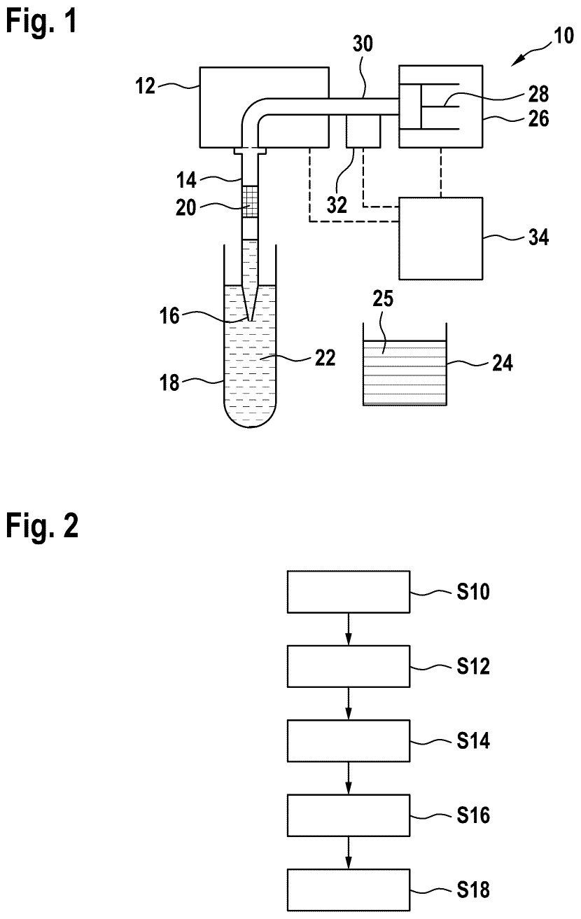

FIG. 2 shows a flow diagram for a method for determining physical parameters of the unknown liquid 22. The method is performed by the controller 34, which performs the measurements with the sensor 32 and which controls the movement of the pipetting arm 12 and the pump 26 by generating corresponding control demands.

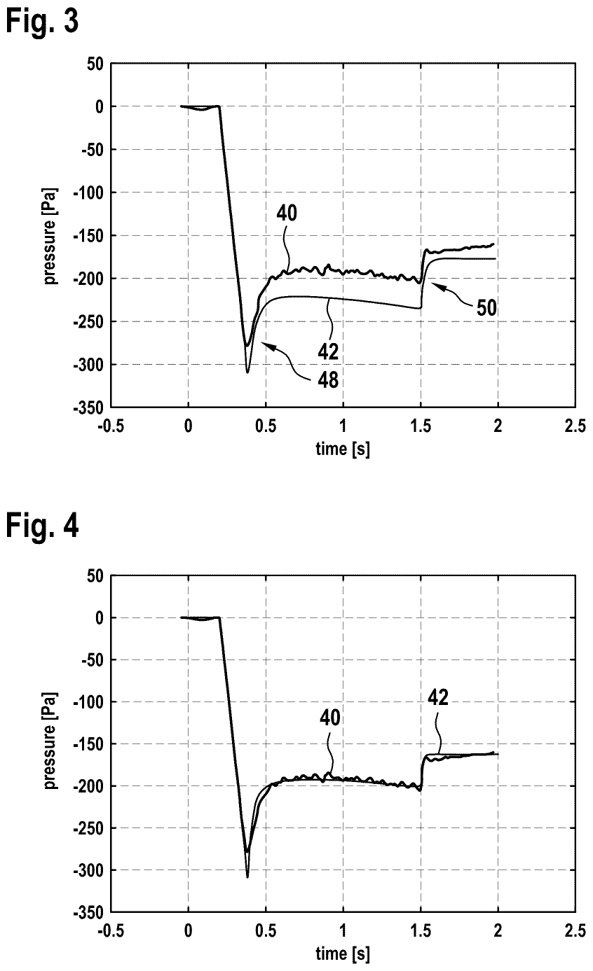

In step S10, the pipetting arm 12 picks up the pipette 14 and lowers the pipette 14 into the known liquid 25. The known liquid 25 is aspirated and/or dispensed with the pipette 14 and during aspirating and/or dispensing, a first measured pressure curve 40 in the pipette 14 is measured. Such a pressure curve is shown in FIGS. 3 and 4.

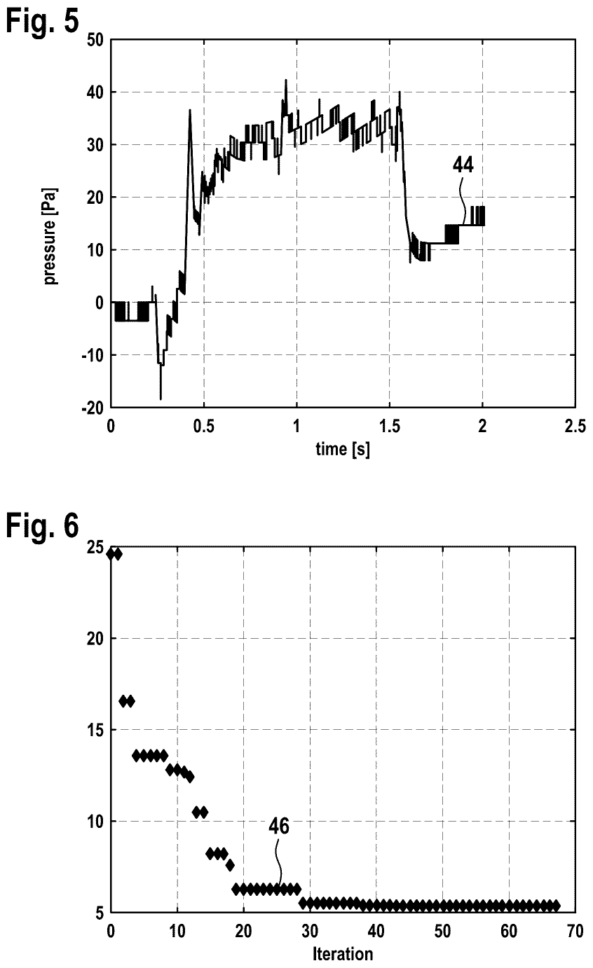

In step S12, physical parameters of the pipette 14 are determined by minimizing an objective function depending on a difference 44 (see FIG. 5) between a simulated pressure curve 42 and the first measured pressure curve 40. FIG. 6 shows values 46 of the objective function at different iterations (see below).

The simulated pressure curve 42 simulates a pressure in the pipette 14 during aspirating and/or dispensing and is calculated based on a physical model of the laboratory automation device 10 including the physical parameters of the pipette 14 and the known physical parameters of the known liquid 25.

The simulated pressure curve 42 is adjusted to the measured pressure curve 40 by adjusting parameters of the physical model, until the simulated pressure curve 42 is (nearly) equal to the measured pressure curve 40.

The optimization process of adjusting the simulated pressure curve 42 to the measured pressure curve 40 is performed iteratively. Starting with a set of physical parameters, the simulated pressure curve 42 is calculated and compared to the measured pressure curve 40. After that in a next iteration step, the physical parameters are varied and the simulated pressure curve 42 is calculated again. In such a way, the physical parameters encoded in the model are varied to minimize the objective function.

FIG. 3 shows a measured pressure curve 40 and a simulated pressure curve 42 at the beginning of the optimization process. The simulated pressure curve 42 deviates from the measured pressure curve 40. FIG. 4 shows the measured pressure curve 40 and a simulated pressure curve 42 at the end of the optimization process. The simulated pressure curve 42 is nearly equal to the measured pressure curve 40.

For determining a new set of physical parameters, different methods are possible, such as a steepest descent method, a genetic algorithm or a Monte Carlo method.

The measure for the difference between the simulated pressure curve 42 and the measured pressure curve 40 is an objective function. The objective function depends on a pressure difference function of the measured pressure curve 40 and the simulated pressure curve 42. Such a difference function 44 is shown in FIG. 5. A pressure difference is calculated at equal time points of the measured pressure curve 40 and the simulated pressure curve 42.

The objective function is determined from the difference function 44. For example, the sum or mean or root mean square of the function values of the difference function 44 may be used. For example, the objective function may be the root mean square of the values of the difference function.

For calculating the objective function, the difference function 44 may be restricted to specific time periods, such as the timer period between start and end of the aspiration process and/or to the time period between start and end of the dispensing process. The respective process may begin, when pressure starts to change actively, and may end, when the pressure changes have been settled. Such a beginning and/or such an end may be determined from the measured pressure curve 40, before calculation of the objective function.

FIG. 6 shows the values 46 of the objective function over several iterations. It can be seen that the objective function becomes smaller and smaller until a plateau is reached, i.e. the objective function has reached a minimum. For example, the optimization may stop, when a change of the objective function has become smaller than a threshold.

In step S12, the physical parameters of the pipette 14 are determined by keeping the physical parameters of the known liquid 25 fixed. Solely the physical parameters of the pipette 14, which may comprise the tip radius and a filter resistance, are varied.

The now determined physical parameters of the pipette 14 are then used in the following method step to determine the physical parameters of the unknown liquid. The physical parameters of the unknown liquid 22 as well as the physical parameters of the known liquid 25 may comprise a density, a viscosity, a surface tension and/or a wetting angle.

In step S14, the pipetting arm 12 disposes the pipette 14 and picks up an equal pipette 14. The equal pipette may be a pipette equally shaped as the pipette 14. For example, the pipette 14 and the equal pipette are picked from the same pipette container and/or manufactured with the same tool.

Alternatively, step S14 is performed with the same pipette 14. For improving the accuracy of the determination of physical parameters, it may be beneficial when the pipette 14 and/or the equal pipette 14 is unused and has not been wetted with a liquid 22, 25 before.

The same or the equal pipette 14 is lowered into the unknown liquid 22. The known liquid 22 is aspirated and optionally dispensed with the pipette 14 and during aspirating and/or dispensing, a second measured pressure curve 40 in the pipette 14 is measured.

In step S16, the physical parameters of the unknown liquid 22 are determined by minimizing the objective function depending on a difference 44 between a simulated pressure curve and the second measured pressure curve 40. The simulation may be performed with the same physical model and with the same objective function. However, in step S16, the physical parameters of the unknown liquid 22 are varied to minimize the objective function and the physical parameters of the pipette 14 are kept fixed.

It may be that in step S16, the physical properties of the unknown liquid 22 are determined in one multidimensional optimization, in which the physical properties of the pipette 14 are varied simultaneously. It also may be that the physical properties of the unknown liquid 22 are determined in a multistep optimization, in which the physical properties of the pipette 14 are varied in separate groups. Such groups may be density and viscosity as well as wetting angle and surface tension.

As a further option, during the optimization processes in step S16, the initial values for the physical parameters may be determined from at least one characteristic feature 48, 50 of the second measured pressure curve 40. Some characteristic features of a measured pressure curve are indicative of estimates of the physical parameters. For example, the height, shape and/or direction (up or down) of the peak 48 (see FIG. 3) at a beginning of the aspiration process is indicative of the density, surface tension and the sign of the wetting angle. Furthermore, the height and/or duration of a pressure change 50 at the end of the aspiration process is indicative of the viscosity.

Such characteristic features 48, 50 may be automatically determined from the measured pressure curve 40, initial values for at least some of the physical parameters of the liquid may be determined therefrom and input into the simulation at the beginning of the iterations.

The physical parameters, which have been determined for the unknown liquid 22, may be displayed on a display of the laboratory automation device 10 and/or may be used further for programming the laboratory automation device 10 and/or for performing an assay procedure with the unknown liquid 22.

In optional step S18, the physical parameters of the unknown liquid 22 are stored in a liquid class for the unknown liquid 22. A liquid class is a data structure, which is used by the laboratory automation device 10 for handling the corresponding liquid. The liquid class contains the physical parameters of the liquid, which are necessary for controlling the handling of the corresponding liquid. The laboratory automation device 10 may then perform an assay procedure with the unknown liquid 22 using the liquid class.

As a further possibility, steps S10 and S12 are omitted and the physical parameters of the pipette are provided in another way. For example, the physical parameters and in particular the geometric parameters are encoded in a computer readable code, such as a bar code, on the pipette 14 and/or a container containing the pipette 14 from which it is picked up. The computer readable code also may contain a link, such that the physical parameters can be queried from a server. The laboratory automation device 10 then may automatically read the computer readable code and may determine the physical parameters in this way, before step S14.

While the embodiments described herein have been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. A single processor or control device or other unit, such as an FPGA, may fulfil the functions of several items recited in the claims. The mere fact that certain measures are recited in mutually different dependent claims does not indicate that a combination of these measures cannot be used to advantage. Any reference signs in the claims should not be construed as limiting the scope.

### LIST OF REFERENCE SYMBOLS AND NOMENCLATURE

10 laboratory automation device
12 pipetting arm
14 pipette
16 pipette tip
18 sample container
20 filter
22 unknown liquid
24 further sample container
25 known liquid
26 pump
28 plunger
30 hose/volume
32 pressure sensor
34 control device
40 measured pressure curve
42 simulated pressure curve
44 difference function
46 objective function value
48 peak
50 pressure change

What is claimed is:

1. A method for determining physical parameters of an unknown liquid to be aspirated and/or dispensed by a laboratory automation device, the method comprising:
determining physical parameters of a pipette, the physical parameters including geometric parameters of the pipette, which at least include a tip radius of an orifice of the pipette;
aspirating and/or dispensing the unknown liquid with a pipette of the laboratory automation device and measuring a measured pressure curve in the pipette during aspirating and/or dispensing;
determining the physical parameters of the unknown liquid by minimizing an objective function depending on a difference between a simulated pressure curve and the measured pressure curve, wherein the simulated pressure curve simulates a pressure in the pipette during aspirating and/or dispensing and is calculated based on a physical model of the laboratory automation device including the physical parameters of the pipette, wherein the physical parameters of the unknown liquid are varied to minimize the objective function.

2. The method of claim 1,
wherein the pressure curve measured during aspirating and/or dispensing the unknown liquid is a second pressure curve;
wherein the method further comprises: aspirating and/or dispensing a known liquid with a pipette and measuring a first measured pressure curve in the pipette during aspirating and/or dispensing;
wherein the physical parameters of the pipette are determined by minimizing the objective function depending on a difference between a simulated pressure curve and the first measured pressure curve, wherein the simulated pressure curve simulates a pressure in the pipette during aspirating and/or dispensing and is calculated based on a physical model of the laboratory automation device including the physical parameters of the pipette and the known physical parameters of the known liquid, wherein the physical parameters of the pipette are varied to minimize the objective function.

3. The method of claim 2,
wherein the known liquid is aspirated with a first pipette and the unknown liquid is aspirated with a second, equal pipette;
wherein the equal pipette is a pipette equally shaped as the pipette; and/or
wherein the pipette and the equal pipette are picked from the same pipette container; and/or
wherein the pipette and the equal pipette are manufactured with the same mold.

4. The method of claim 1,
wherein at least one initial value for the physical parameters are determined from at least one characteristic feature of the second measured pressure curve;
wherein the at least one characteristic feature includes:
a height and/or direction of a peak at a beginning of the aspiration;
a height and/or duration of a pressure change at an end of the aspiration.

5. The method of claim 1,
wherein the geometric parameters of the pipette comprise additionally at least one of: a geometric model of at least one conical section modelling an interior surface the pipette; an opening angle of a conical section ending in the orifice; a second radius at another end of the conical section; a distance of the other end to the orifice; an opening angle and/or radii and/or distances of ends of further conical sections.

6. The method of claim 1,
wherein the physical parameters of the pipette additionally comprise a filter resistance; /and/or
wherein the physical parameters of the unknown liquid comprise at least one of a density, a viscosity, a surface tension and a wetting angle.

7. The method of claim 1, further comprising:
aspirating and dispensing the unknown liquid with the laboratory automation device and measuring the measured pressure curve during aspirating and dispensing;
wherein the simulated pressure curve simulates a pressure in the pipette during aspirating and dispensing;
wherein the objective function depends on the difference between the simulated pressure curve and the measured pressure curve during aspirating and dispensing.

8. The method of claim 1,
wherein the objective function depends on pressure differences of the measured pressure curve and the simulated pressure curve at equal time points.

9. The method of claim 1,
wherein physical properties of the unknown liquid are determined in one multidimensional optimization, in which the physical properties of the pipette are varied simultaneously; or
wherein the physical properties of the unknown liquid are determined in a multistep optimization, in which the physical properties of the pipette are varied in separate groups of one or more parameters.

10. The method of claim 1,
wherein the pipette is unused and has not been wetted with a liquid before.

11. The method of claim 1, further comprising:
storing the physical parameters of the unknown liquid in a liquid class for the unknown liquid;
performing an assay procedure with the unknown liquid using the liquid class.

12. A computer-readable medium storing a computer program for determining physical parameters of an unknown liquid, which computer program, when being executed by a processor, is adapted to carry out the steps of the method of claim 1.

13. A laboratory automation device, comprising:
a pipetting arm for carrying a pipette;
a pump for changing a pressure in a volume connected to the pipette;
a pressure sensor for pressure measurements in the volume connected to the pipette;
a control device for controlling the pump and the pipetting arm and for receiving a pressure signal from the pressure sensor;
wherein the control device is adapted for performing the method of claim 1.
